(19) United States
(12) Patent Application Publication
(10) Pub. No.: US 2009/0216386 A1
(43) Pub. Date: Aug. 27, 2009

(54) LOAD SHED TRANSFER MECHANISM AND METHOD

(76) Inventor: Francis X. Wedel, Lake Mills, WI (US)

Correspondence Address: BOYLE FREDRICKSON S.C., 840 North Plankinton Avenue, MILWAUKEE, WI, 53203, US

(21) Appl. No.: 12/037,500

(22) Filed: Feb. 26, 2008

(51) Int. Cl. H02J 3/06

(52) U.S. Cl. 700/295

(57) ABSTRACT

A transfer mechanism and method are provided for transferring the supply of electrical power on a load between a utility source and a stand-by electrical generator wherein load includes an essential load and a secondary load. The transfer mechanism includes a transfer switch that transfers the supply of electrical power to the output between the utility source and the generator. A load shed controller is operatively connected to the output of the transfer switch for monitoring the electrical power supplied to the secondary load. The load shed controller terminates the electrical power supplied to the secondary load in response to the generator being overloaded.

### FIELD OF THE INVENTION

This invention relates generally to stand-by electrical generators, and in particular, to a transfer mechanism and method for transferring the supply of electrical power from a utility source to a stand-by electrical generator that allows for the shedding of a portion of the load in the event that the stand-by electrical generator is overloaded.

### BACKGROUND AND SUMMARY OF THE INVENTION

As is known, virtually all residential homes utilize electrical power received from a utility company. Typically, utility companies have an excellent record of providing uninterrupted or infrequently interrupted power to their customers at proper voltage levels and line frequency. However, due to the increasing demand for power, power outages have become more frequent. While power outages usually last only for a short duration, an extended power outage may cause more than simple aggravation for customers of the utility. A power outage may render a homeowner's appliances, such as the sump pump, refrigerator or freezer inoperable. If a power outage occurs during a rainstorm, the failure of the sump pump to operate may result in the flooding of the homeowner's basement.

In order to combat these occasional disruptions in service, many residential customers of the utility companies have equipped their homes with stand-by electrical generator systems. These stand-by electrical generator systems include internal combustion engines that drive electrical generators. If the commercial power from the utility company fails, the internal combustion engine of the stand-by electrical generator system is automatically started causing the electrical generator to generate electrical power. When the electrical power generated by the electrical generator reaches the proper voltage and frequency desired by the customer, a transfer mechanism transfers the load imposed by the homeowner from the commercial power lines to the electrical generator.

Typically, the transfer mechanism incorporates switches that isolate the electrical power supplied by the utility company from the generator. In a residential application, the switches are flipped either manually or automatically between the utility source and the generator in order to provide power to the electrical system of the home. These prior art transfer mechanisms transfer the entire electrical system of the home onto the generator. Recent changes to the National Electric Code have mandated that newly installed stand-by electrical generators must be sized to carry the entire load to which the generator may be connected. It can be appreciated that the demands of the entire electrical system of a home can be quite significant. As a result, the generator must be of sufficient size to power the entire electrical system of the home. This, in turn, increases the overall cost of the stand-by electrical generator system for the homeowner.

Therefore, it is a primary object and feature of the present invention to provide a transfer mechanism and method for transferring the supply of electrical power from a utility source to a stand-by electrical generator that allows for the shedding of a portion of an electrical load in the event that the stand-by electrical generator overloaded.

It is a further object and feature of the present invention to provide a transfer mechanism and method that automatically transfers the electrical power supplied to an electrical load between a utility source and a stand-by electrical generator in response to a power outage.

It is a still further object and feature of the present invention to provide a transfer mechanism for transferring the electrical power supplied to an electrical load between a utility source and a stand-by electrical generator that may be simply and easily installed.

In accordance with the present invention, a transfer mechanism is provided for transferring the supply of electrical power on a load between a utility source and a stand-by electrical generator wherein the load includes an essential load and a secondary load. The transfer mechanism includes a transfer switch having a utility input connectable to the utility source, a generator input connectable to the generator, and an output connectable to the essential load. The transfer switch transfers the supply of electrical power to the output between the utility source and the generator. A load shed switch has an input connectable to the output of the transfer switch and an output operatively connected to the secondary load. The load shed switch is movable between a closed position wherein the secondary load is connected to the output of the transfer switch and an open position were the secondary load is isolated from the output of the transfer switch. A load shed controller is operatively connected to the load shed switch. The load shed controller monitors the electrical power supplied to the secondary load and moves the load shed switch from the closed position to the open position in response to a predetermined property of the electrical power supplied to the secondary load varying from a predetermined level.

It is contemplated for the predetermined property to be the frequency of the electrical power supplied to the secondary load. It is further contemplated for the load shed controller to move the load shed switch to a closed position at a first predetermined time period after the load shed switch is moved to open position. A retry switch is operatively connected to the load shed controller. The retry switch is movable between a non-actuated position and an actuated position wherein the load shed controller moves the load shed switch from the open position to the closed position. The load shed controller includes a visual display. The visual display provides a visually observable signal in response to the load shed switch being in the open position. The load shed controller also includes a power source operatively connected to the output of the transfer switch. The power source supplies power to the load shed controller.

In accordance with a further aspect of the present invention, a transfer mechanism is provided for transferring the supply of electrical power on a load between a utility source and a stand-by electrical generator. The load includes an essential load and a secondary load. The transfer mechanism includes a transfer switch having a utility input connectable to the utility source, a generator input connectable to the generator, and an output connectable to the essential and the secondary loads. The transfer switch transfers the supply of electrical power to the output between the utility source and the generator. A load shed controller is operatively connected to the output of the transfer switch for monitoring the electrical power supplied to the secondary load. The load shed controller terminates the electrical power supplied to the secondary load in response to a predetermined property of the electrical power supplied to the secondary load varying from a predetermined level. It is contemplated for the predetermined property to be the frequency of the electrical power supplied to the secondary load.

The transfer mechanism may include a load shed switch having an input connectable to the output of the transfer switch and an output operatively connected to the secondary load and being connectable to the load shed controller. The load shed controller moves the load shed switch between a closed position wherein the secondary load is connected to the output of the transfer switch and an open position were the secondary load is isolated from the output of the transfer switch. The load shed controller moves the load shed switch from the closed position to the open position in response to the predetermined property of the electrical power supplied to the secondary load varying from the predetermined level. The load shed controller moves the load shed switch to a closed position at a first predetermined time period after the load shed switch is moved to the open position.

A retry switch is operatively connected to load shed controller. The retry switch is movable between a non-actuated position and an actuated position wherein the load shed controller moves the load shed switch from the open position to the closed position. The load shed controller includes a visual display. The visual display provides a visually observable signal in response to the load shed switch being in the open position. The load shed controller also includes a power source operatively connected to the output of the transfer switch. The power source supplies power to the load shed controller.

In accordance with a still further aspect of the present invention, a method of supplying electrical power to a load is provided. The load includes an essential load and a secondary load. The method includes the steps supplying electrical power to the essential load and the secondary load and monitoring the electrical power supplied to the secondary load. The electrical power supplied to the secondary load is terminated in response a predetermined property of the electrical power supplied to the secondary load varying from a predetermined value.

The step of supplying electrical power includes the additional steps transferring the supply of electrical power from the utility source to the generator in response to a power outage by the utility source and interconnecting the generator to the essential load and to the secondary load. The step of interconnecting the generator to the essential load and to the secondary load includes the additional step of providing a transfer switch having a utility input connectable to the utility source, a generator input connectable to the generator, and an output connectable to the essential load. The transfer switch transfers the supply of electrical power to the output between the utility source and the generator. The output of the transfer switch is connected to the secondary load with a load shed switch. The load shed switch is movable between a closed position wherein the secondary load is connected to the output of the transfer switch and an open position were the secondary load is isolated from the output of the transfer switch.

A visually observable signal is provided in response to the load shed switch being in the open position. The predetermined property is the frequency of the electrical power supplied to the secondary load. The electrical power supplied to the secondary load is reconnected at predetermined time period after termination.

### BRIEF DESCRIPTION OF THE DRAWINGS

The drawings furnished herewith illustrate a preferred construction of the present invention in which the above advantages and features are clearly disclosed as well as other which will be readily understood from the following description of the illustrated embodiment. In the drawings:

FIG. 1 is a schematic view of a transfer mechanism in accordance with the present invention; and

FIG. 2 is a flow chart of the methodology of the present invention.

### DETAILED DESCRIPTION OF THE DRAWINGS

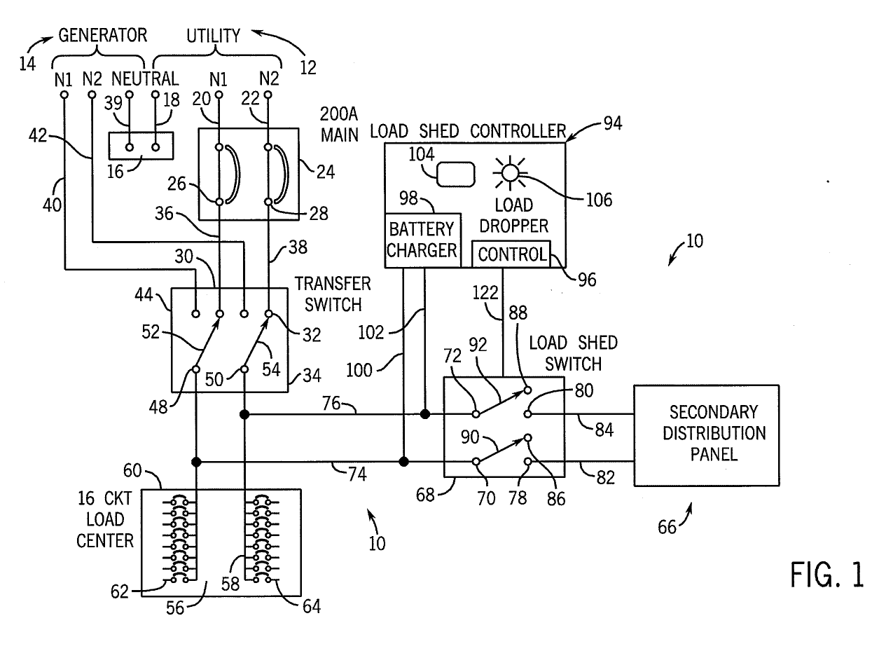

Referring to FIG. 1, a transfer mechanism in accordance with the present invention is generally designated by the reference numeral 10. It is contemplated for transfer mechanism 10 to be mounted within a housing, cabinet or the like. Transfer mechanism 10 is interposed between a utility source 12 and a stand-by electrical generator 14. As is conventional, utility source 12 is interconnected to a neutral point 16 through line 18 and supplies ±120 volts across lines 20 and 22. Lines 20 and 22 are connected to main circuit breaker 24 of a main distribution panel located within the interior of a building. The outputs 26 and 28 of main circuit breaker 24 are interconnected to corresponding first and second utility inputs 30 and 32, respectively, of transfer switch 34 by lines 36 and 38.

Generator 14 is interconnected to neutral point 18 through line 39 and supplies ±120 volts across lines 40 and 42 when actuated. Lines 40 and 42 are interconnected to corresponding first and second generator inputs 44 and 46, respectively, of transfer switch 34. Transfer switch 34 includes first and second movable contacts 52 and 54, respectively, and first and second outputs 48 and 50, respectively. First and second movable contacts 52 and 54, respectively, of transfer switch 34 are movable between a first position wherein the first and second movable contacts 52 and 54, respectively, electrically couple first and second utility inputs 30 and 32, respectively, of transfer switch 34 to corresponding first and second outputs 48 and 50, respectively, of transfer switch 34, and a second position wherein first and second movable contacts 52 and 54, respectively, electrically connect first and second generator inputs 44 and 46, respectively, to corresponding first and second outputs 48 and 50, respectively, of transfer switch 34.

Under normal operating conditions such that utility source 12 is providing electrical power, first and second movable contacts 52 and 54,respectively, of transfer switch 34 remain in the first position wherein first and second utility inputs 30 and 32, respectively, are coupled to first and second outputs 48 and 50, respectively, of transfer switch 34. In response to a power outage from utility source 12, generator 14 is actuated and first and second movable contacts 52 and 54, respectively, of transfer switch 34 move from the first position to the second position wherein first and second generator inputs 44 and 46, respectively, are electrically coupled to first and second outputs 48 and 50, respectively, of transfer switch 34 such that generator 14 provides electrical power to a load connected to the first and second outputs 48 and 50, respectively, of transfer switch 34. In response to the restoration of power from the utility source 12, generator 14 is stopped. Thereafter, first and second movable contacts 52 and 54, respectively, of transfer switch 34 are moved from the second position to the first position so as to electrical couple first and second outputs 48 and 50, respectively, of transfer switch 34 to utility source 12.

It can be appreciated that generator 14 may be manually started in response to a power outage from utility source 12 and stopped in response to the restoration of electrical power. In addition, it is contemplated to manually operate first and second movable contacts 52 and 54, respectively, between the first and second positions. Alternatively, an automatic transfer mechanism may be used such as the transfer mechanism disclosed in U.S. Pat. No. 6,181,028, assigned to the assignee of the present invention and incorporated herein by reference. The automatic transfer mechanism includes a monitoring system for monitoring the power supplied by the utility source. The monitoring system starts the generator in response to power outage from the utility source and stops the generator in response to the restoration of power from the utility source. Electrically controlled movable contacts selectively interconnect the outputs of the transfer switch to either the utility source or the generator.

First and second outputs 48 and 50, respectively, of transfer switch 34, are electrically coupled to corresponding first and second bus bars 56 and 58, respectively, of essential load distribution panel 60. A plurality of single pole and/or double pole circuit breakers 62 and 64 are electrically coupled to bus bars 56 and 58. Circuit breakers 62 and 64 are operatively connected to corresponding individual branch circuits within the building so as to supply 120 and/or 240 volt service to essential loads, such as the furnace, within the building.

First and second outputs 48 and 50, respectively, of transfer switch 34 are also electrically coupled to a non-essential or secondary distribution panel 66 by load shed switch 68. Load shed switch 68 includes first and second inputs 70 and 72, respectively, electrically coupled to first and second outputs 48 and 50, respectively, of transfer switch 34 by corresponding lines 74 and 76, respectively. Load shed switch 68 further includes first and second load outputs 78 and 80, respectively, electrically coupled to the bus bars of secondary load distribution panel 66 by corresponding lines 82 and 84. Load shed switch 68 further includes first and second no-load outputs 86 and 88, respectively, and first and second movable contacts 90 and 92, respectively. First and second movable contacts 90 and 92, respectively, of load shed switch 68 are movable between a first position wherein first and second movable contacts 90 and 92, respectively, electrically couple first and second secondary load outputs 78 and 80, respectively, to corresponding first and second outputs 48 and 50, respectively, of transfer switch 34 and a second position wherein first and second movable contacts 90 and 92, respectively, of load shed switch 68 interconnect first and second no load outputs 86 and 88, respectively, to first and second outputs 48 and 50, respectively, of transfer switch 34 such that secondary distribution panel 66 is isolated from the electrical power provided at first and second outputs 48 and 50, respectively, of transfer switch 34 by generator 14.

The position of first and second movable contacts 90 and 92, respectively, of load shed switch 68 is controlled by load shed controller 94. Load shed controller 94 includes a central processing unit 96 for effectuating the methodology of the present invention. Central processing unit 96 is powered by a battery charger 98 operatively connected to the first and second outputs 48 and 50, respectively, of transfer switch 34, by corresponding lines 100 and 102. Load shed controller 94 further includes a plurality of dip switches (not shown) operatively connected to central processing unit 96 that allow a user to define the various operating parameters of central processing unit 96. More specifically, the dip switches allow a user to identify the operating frequency of generator 14; set the time periods for the underfrequency and reconnect timers, hereinafter described; specify if central processing unit 96 should automatically attempt to recouple secondary distribution panel 66 to first and second outputs 48 and 50, respectively, of transfer switch 34 after an overload condition on generator 14; and specify if central processing unit 96 should execute a single attempt to recouple secondary distribution panel 66 to first and second outputs 48 and 50, respectively, of transfer switch 34 after an overload condition on generator 14 or attempt to recouple secondary distribution panel 66 to first and second outputs 48 and 50, respectively, of transfer switch 34 after each overload condition on generator 14. Load shed controller 94 further includes manual retry switch 104 and visual display 106 operatively connected to central processing unit 96, for reasons hereinafter described.

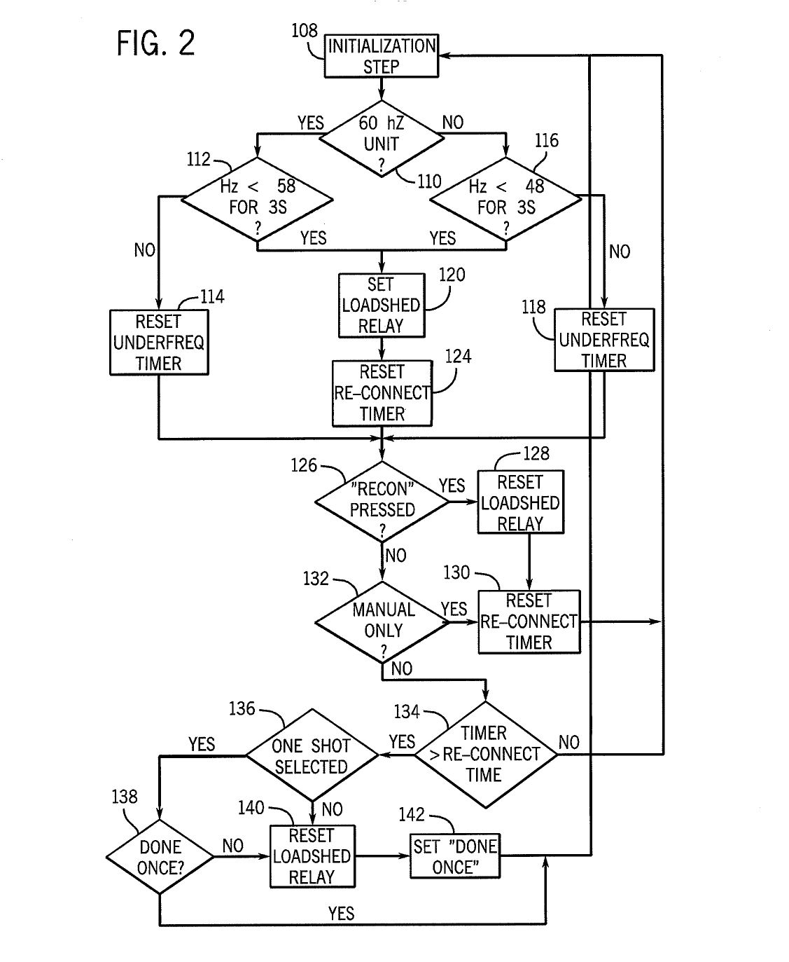

Referring to FIG. 2, in operation, central processing unit 96 is initialized, block 108. Central processing unit 96 scans the dip switches and determines if the electrical power provided at first and second outputs 48 and 50, respectively, of transfer switch 34 is supplied by utility source 12 or generator 14. If the electrical power at first and second outputs 48 and 50, respectively, of transfer switch 34 is supplied by utility source 12, first and second movable contacts 90 and 92, respectively, of load shed switch 68 are provided in the first position such that secondary distribution panel 66 is electrically coupled to first and second outputs 48 and 50, respectively, of transfer switch 34. In the event of a power outage from utility source 12, central processing unit 96 monitors the frequency of the electrical power supplied at first and second outputs 48 and 50, respectively, of transfer switch 34. If the frequency of the electrical power supplied at first and second outputs 48 and 50, respectively, of transfer switch 34 drops below a predetermined level for a predetermined period of time, generator 14 is in an overload condition.

Initially, central processing unit 96 determines the normal operating frequency of generator 14, block 110, based upon the settings of the dip switches, as heretofore described. In the event that generator 14 is a 60 hertz unit, central processing unit 96 determines if the frequency of the electrical power supplied at first and second outputs 48 and 50, respectively, of transfer switch 34, drops below a predetermined level, e.g., 58 hertz, for a predetermined period of time, e.g., three seconds, block 112. The predetermined time period is monitored with underfrequency timer, heretofore described. If the frequency of the electrical power supplied at first and second outputs 48 and 50, respectively, of transfer switch 34, does not drop below the predetermined level for the predetermined time period, the underfrequency timer for counting the predetermined time period is reset, block 114. Similarly, if it is intended for generator 14 to operate at 50 hertz, central processing unit 96 monitors electrical power supplied at first and second outputs 48 and 50, respectively, of transfer switch 34 to determine if the frequency drops below a predetermined level, e.g., 48 hertz, for the predetermined time period, three seconds, block 116. Once again, if the frequency of the electrical power at first and second outputs 48 and 50, respectively, of transfer switch 34 does not drop below the predetermined level for the predetermined period of time, the underfrequency timer counting the predetermined time period is reset, block 118.

In the event that the frequency of the electrical power supplied at first and second outputs 49 and 50, respectively, of transfer switch 34, drops below the predetermined level for the predetermined time period, central processing unit 96 actuates a load shed relay (not shown), block 120, through a signal on line 122. The load shed relay is operatively connected to first and second movable contacts 90 and 92, respectively, such that upon actuation, the load shed relay moves first and second movable contacts 90 and 92, respectively, of load shed switch 68 from the first position to the second position wherein the secondary distribution panels 66 is isolated from the electrical power supplied at first and second outputs 48 and 50, respectively, of transfer switch 34, thereby reducing the load on generator 14. In addition, central processing unit 96 resets the reconnect timer (not shown), block 124. With secondary distribution panel 66 isolated from the first and second outputs 48 and 50, respectively, of transfer switch 34, central processing unit 96 illuminates visual display 106 so as to advise a user that electrical power is no longer is being provided to secondary distribution panel 66.

In order to reconnect secondary distribution panel 66 to the electrical power supplied at first and second outputs 48 and 50, respectively, of transfer switch 34, a user may actuate manual retry switch 104, block 126. If manual retry switch 104 is actuated, central processing unit 96 resets the load shed relay, block 128, such that first and second manual contacts 90 and 92, respectively, of load shed switch 68 return to the first position wherein the secondary distribution panel 66 is electrically coupled to first and second outputs 48 and 50, respectively, of transfer switch 34. In addition, the reconnect timer is reset, block 130. Thereafter, central processing unit 96 returns to its initialization step, block 108, and the process is repeated. If a user desires only manual reconnection, block 132, and the manual retry switch 104 has not been depressed, the reconnect timer is reset, block 130, and central processing unit 96 returns to its initialization step, block 108. If the user has programmed central processing unit 96 to automatically attempt to recouple secondary distribution panel 66 to first and second outputs 48 and 50, respectively, of transfer switch 34, the reconnect timer is monitored, block 134. The reconnect time period is set by a user utilizing the dip switches, heretofore described. If the user selected, reconnect time period has not elapsed, central processing unit 96 returns the initialization step, block 108, and the process is repeated.

The user may program the central processing unit 96 to repeatedly attempt to reconnect secondary distribution panel 66 to the first and second outputs 48 and 50, respectively, of transfer switch 34 after each overload condition on generator 14 or only after the first occurrence of an overload condition. In the event the user has programmed central processing unit 96, block 136, to reestablish the electrical connection between secondary distribution panel 66 and the first and second outputs 48 and 50, respectively, of transfer switch 34 only once, central processing unit 96 determines if it has previously attempted to recouple secondary distribution panel 66 and the first and second outputs 48 and 50, respectively, of transfer switch 34, block 138. If central processing unit 96 had previously attempted to recouple secondary distribution panel 66 and the first and second outputs 48 and 50, respectively, of transfer switch 34, central processing unit 96 returns to its initialization step, block 108, and load shed switch 68 remains in its second position isolating the secondary distribution panel 66 from first and second outputs 40 and 50, respectively, of transfer switch 34.

In the event that central processing unit 96 did not previously attempt to reestablish electrical contact between secondary distribution panel 66 and first and second outputs 48 and 50, respectively, of transfer switch 34, central processing unit 96 resets the load shed relay, block 140, and sets a flag, block 142, confirming the attempt of central processing unit 96 to reestablish the electrical connection between secondary distribution panel 66 and first and second outputs 40 and 50, respectively, of transfer switch 34. Thereafter, central processing unit 96 returns to its initialization step, block 108. Alternatively, if a user has not limited central processing unit 96 to a single attempt to reestablish the electrical connection between secondary distribution panel 66 and first and second outputs 48 and 50, respectively, of transfer switch 34, central processing unit 96 resets the load shed relay, block 140, such that first and second moveable contacts 90 and 92, respectively, of load shed switch 68 return to the first position wherein secondary distribution panel 66 is electrically coupled to the first and second outputs 48 and 50, respectively, of transfer switch 34 of block 140. Thereafter, the flag specifying the attempt to electrically couple between secondary distribution center 66 and first and second outputs 50 and 52, respectively, of transfer switch 34 is set, block 142, and central processing unit 96 returns to its initialization step, block 108. The process is repeated until the electrical power provided by utility source 12 is restored and transfer switch 34 reconnects the essential load distribution panel 60 and secondary distribution panel 66 to utility source 12.

It can be appreciated that the above-described methodology allows for the transferring of the supply of electrical power from a utility source to a stand-by electrical generator wherein a portion of the load on the generator may be shed in the event that the stand-by electrical generator is overloaded. Various modes of carrying out the invention are contemplated as being within the scope of the following claims particularly pointing out and distinctly claiming the subject matter which is regarded as the invention.

I claim:

1. A transfer mechanism for transferring the supply of electrical power on a load between a utility source and a stand-by electrical generator, the load including an essential load and a secondary load, the transfer mechanism comprising:
a transfer switch having a utility input connectable to the utility source, a generator input connectable to the generator, and an output connectable to the essential load, the transfer switch transferring the supply of electrical power to the output between the utility source and the generator;
a load shed switch having an input connectable to the output of the transfer switch and an output operatively connected to the secondary load, the load shed switch movable between a closed position wherein the secondary load is connected to the output of the transfer switch and an open position were the secondary load is isolated from the output of the transfer switch; and
a load shed controller operatively connected to the load shed switch, the load shed controller monitoring the electrical power supplied to the secondary load and moving the load shed switch from the closed and the open positions in response to a predetermined property of the electrical power supplied to the secondary load varying from a predetermined level.

2. The transfer mechanism of claim 1 wherein the electrical power has a frequency and wherein the predetermined property is the frequency of the electrical power supplied to the secondary load.

3. The transfer mechanism of claim 1 wherein the load shed controller moves the load shed switch to a closed position at a first predetermined time period after the load shed switch is moved to open position.

4. The transfer mechanism of claim 1 further comprising a retry switch operatively connected to the load shed controller, the retry switch movable between a non-actuated position and an actuated position wherein the load shed controller moves the load shed switch from the open position to the closed position.

5. The transfer mechanism of claim 1 wherein the load shed controller includes a visual display, the visual display providing a visually observable signal in response to the load shed switch being in the open position.

6. The transfer mechanism of claim 1 wherein the load shed controller includes a power source operatively connected to the output of the transfer switch, the power source supplying power to the load shed controller.

7. A transfer mechanism for transferring the supply of electrical power on a load between a utility source and a stand-by electrical generator, the load including an essential load and a secondary load, the transfer mechanism comprising:
a transfer switch having a utility input connectable to the utility source, generator input connectable to the generator, an output connectable to the essential and the secondary loads, the transfer switch transferring the supply of electrical power to the output between the utility source and the generator; and
a load shed controller operatively connected to the output of the transfer switch for monitoring the electrical power supplied to the secondary load, the load shed controller terminating the electrical power supplied to the secondary load in response to a predetermined property of the electrical power supplied to the secondary load varying from a predetermined level.

8. The transfer mechanism of claim 7 wherein the electrical power has a frequency and wherein the predetermined property is the frequency of the electrical power supplied to the secondary load.

9. The transfer mechanism of claim 7 further comprising a load shed switch having an input connectable to the output of the transfer switch, an output operatively connected to the secondary load and being connectable to the load shed controller, the load shed controller moving the load shed switch between a closed position wherein the secondary load is connected to the output of the transfer switch and an open position were the secondary load is isolated from the output of the transfer switch.

10. The transfer mechanism of claim 9 wherein the load shed controller moves the load shed switch from the closed position to the open position in response to the predetermined property of the electrical power supplied to the secondary load varying from the predetermined level.

11. The transfer mechanism of claim 9 wherein the load shed controller moves the load shed switch to a closed position at a first predetermined time period after the load shed switch is moved to the open position.

12. The transfer mechanism of claim 9 further comprising a retry switch operatively connected to load shed controller, the retry switch movable between a non-actuated position and an actuated position wherein the load shed controller moves the load shed switch from the open position to the closed position.

13. The transfer mechanism of claim 9 wherein the load shed controller includes a visual display, the visual display providing a visually observable signal in response to the load shed switch being in the open position.

14. The transfer mechanism of claim 7 wherein the load shed controller includes a power source operatively connected to the output of the transfer switch, the power source supplying power to the load shed controller.

15. A method of supplying electrical power to a load, the load including an essential load and a secondary load, comprising the steps of:
supplying electrical power to the essential load and the secondary load;
monitoring the electrical power supplied to the secondary load; and
terminating the electrical power supplied to the secondary load in response a predetermined property of the electrical power supplied to the secondary load varying from a predetermined value.

16. The method of claim 15 wherein the step of supplying electrical power includes the additional steps:
transferring the supply of electrical power from a utility source to a generator in response to a power outage by the utility source; and
interconnecting the generator to the essential load and to the secondary load.

17. The method of claim 16 wherein the step of interconnecting the generator to the essential load and to the secondary load includes the additional steps of:
providing a transfer switch having a utility input connectable to the utility source, a generator input connectable to the generator, and an output connectable to the essential load, the transfer switch transferring the supply of electrical power to the output between the utility source and the generator; and
connecting the output of the transfer switch to the secondary load with a load shed switch, the load shed switch movable between a closed position wherein the secondary load is connected to the output of the transfer switch and an open position were the secondary load is isolated from the output of the transfer switch.

18. The method of claim 17 comprising the additional step of providing a visually observable signal in response to the load shed switch being in the open position.

19. The method of claim 15 wherein the electrical power has a frequency and wherein the predetermined property is the frequency of the electrical power supplied to the secondary load.

20. The method of claim 15 comprising the additional step of reconnecting the electrical power supplied to the secondary load at predetermined time period after termination.
